(19) United States
(12) Patent Application Publication
(10) Pub. No.: US 2006/0236088 A1
(43) Pub. Date: Oct. 19, 2006

(54) Technique for encrypting communications

(75) Inventor: Edward Walter, Boerne, TX (US)

Correspondence Address: HANLEY, FLIGHT & ZIMMERMAN, LLC, 20 N. WACKER DRIVE, SUITE 4220, CHICAGO, IL, 60606, US

(73) Assignee: SBC KNOWLEDGE VENTURES, L.P., RENO, NV (US)

(21) Appl. No.: 11/104,878

(22) Filed: Apr. 13, 2005

(51) Int. Cl. H04L 9/00

(52) U.S. Cl. 713/150

(57) ABSTRACT

A download image containing an encryption agent and a soft key software routine is downloaded to a communication unit coupled to a communications network. The encryption agent enables the communication unit to encrypt/decrypt communications handled by the unit. The soft key routine enables/disables encryption at the unit based on a selection of a soft key on the unit. If encryption is enabled, the encryption agent encrypts/decrypts communications transferred between the communication unit and the communication network. If encryption is disabled, the communications are transferred “in the clear” between the communication unit and the communications network.

### BACKGROUND OF THE INVENTION

Certain organizations may have a need to encrypt communications between two parties in a telephone conversation. For example, a business may wish to encrypt a conversation containing information that is sensitive to the business to avoid having the information fall into the wrong hands. Often telephone service providers provide encryption services that a subscriber, such as a business, may subscribe to in order to encrypt voice communications for the subscriber.

In a typical arrangement, voice communications originating at a source and destined for a destination are encrypted by a gateway device which may lie between the telecommunications equipment used at the source and a communications network, such as the public switch telephone network (PSTN). Here, communications may be handled by the telecommunications equipment “in the clear” (i.e., the communications are not encrypted) and transferred from the telecommunication equipment to the gateway device which encrypts the communications and transfers the encrypted communications onto the communications network. At the destination end, the encrypted communications are received from the communications network by a gateway associated with the destination, decrypted by the destination's gateway and transferred “in the clear” to the destination by the destination's telecommunication equipment.

In other arrangements, encryption and decryption may be performed in hardware at the source and destination using specially equipped communication units (e.g., telephones) which are part of the source and destination's telecommunication equipment. In these arrangements, encryption tends to be more secure as data is encrypted at the communication unit and passed to the gateway in an encrypted form rather than being passed to the gateway “in the clear.”

### SUMMARY OF THE INVENTION

One problem associated with passing communications “in the clear” is that the communications are vulnerable to falling into the wrong hands prior to being encrypted. For example, in the arrangement described above, communications handled by the telecommunications equipment is vulnerable to being monitored prior to being encrypted at the gateway.

One problem with encrypting communications at a communication unit wherein encryption is incorporated in hardware at the unit is that the technique used to encrypt/decrypt the data tends to be hard-coded and not very flexible. Further, since the encryption is provided by hardware, handsets that do not have the proper hardware may not be able to encrypt/decrypt communications.

The present invention overcomes the above and other shortcomings by incorporating a technique that encrypts/decrypts communications that originate at a communication unit utilizing a soft-loaded encryption agent. According to an aspect of the present invention, a software encryption agent is downloaded to a communication unit which installs the software encryption agent and uses the installed agent to encrypt/decrypt communications transferred between the communication unit and a communications network.

In an illustrated embodiment of the invention, a download image containing the encryption agent and a soft key agent is downloaded to a communication unit coupled to a communications network. The encryption agent enables the communication unit to encrypt/decrypt communications handled by the unit. Illustratively, the communications are voice communications. The soft key routine enables/disables encryption at the unit based on a selection of a soft key on the unit. If encryption is enabled, the encryption agent encrypts/decrypts communications transferred between the communication unit and the communication network. If encryption is disabled, the communications are transferred “in the clear” between the communication unit and the communications network.

Advantageously, by encrypting communications at a communication unit, the present invention overcomes shortcomings that may exist if the communications were carried “in the clear” outside the communication unit. Further, since the encryption agent is soft loaded into the communication unit, the present invention overcomes shortcomings associated with having to have special hardware in the unit to accommodate encrypting/decrypting communications.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an exemplary communication network that may be used with the present invention.

FIG. 2 is a high-level partial schematic block diagram of a server that may be used with the present invention.

FIG. 3 is a block diagram of a communication unit that may be used with the present invention.

FIG. 4 is a high-level partial schematic block diagram of processing logic that may be used with the present invention.

FIG. 5 is a flow chart of a sequence of steps that may be used to control the operation of soft keys on a communication unit in accordance with the present invention.

FIG. 6 is a flow chart of a sequence of steps that may be used to download an encryption agent and establish soft keys on a communication unit in accordance with an aspect of the present invention.

FIG. 7 is a flow chart of a sequence of steps that may be used to transfer communications between communication units in accordance with an aspect of the present invention.

FIG. 8 is a flow chart of a sequence of steps that may be used to receive and process communications acquired at a communication unit in accordance with an aspect of the present invention.

FIG. 9 is a flow chart of a sequence of steps that may be used to establish encrypted communications between communication units and transfer encrypted communications between the communication units in accordance with an aspect of the present invention.

### DETAILED DESCRIPTION OF THE INVENTION

A description of preferred embodiments of the invention follows.

Embodiments of the present invention described below describe the present invention as used with Voice over Internet Protocol (VoIP) networks. It should be noted however the present invention may be adapted to be used with other types of communication networks, such as, for example, the public switched telephone network (PSTN).

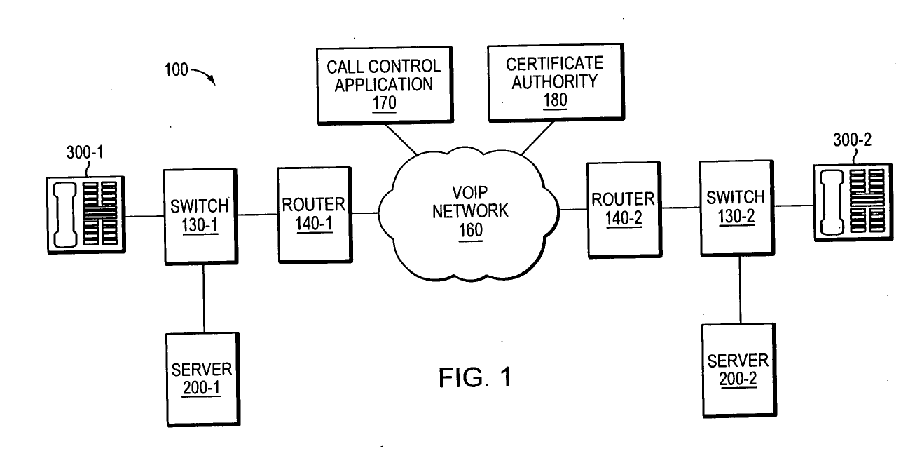

FIG. 1 is a high-level schematic block diagram of an exemplary communications network that may be used with the present invention. Network 100 comprises various nodes including communication units 300-1, 300-2, switches 130-1, 130-2, routers 140-1, 140-2, servers 200-1, 200-2, a call control application 170 and a certificate authority 180, interconnected via a VoIP network 160 to form an internetwork of nodes. The communication units 300 are illustratively telephone units that are capable of originating voice and/or text information that is transmitted via network 100 between the communication units. Switches 130 are conventional data switches used to interface the communication units 300 with the routers 140. Further, switches 130 enable communication between the servers 200-1, 20-2 and the communication units 300. Routers 140 are illustratively conventional VoIP gateway devices that interface the data traffic carried by the switches with the VoIP network 160. Call control application 170 is a conventional VoIP platform that is configured to maintain calls made between the communication units 300. Certificate authority 180 is a conventional server that is illustratively configured to provide public key and private key information that is used by the communication units to encrypt/decrypt communications transferred on network 100.

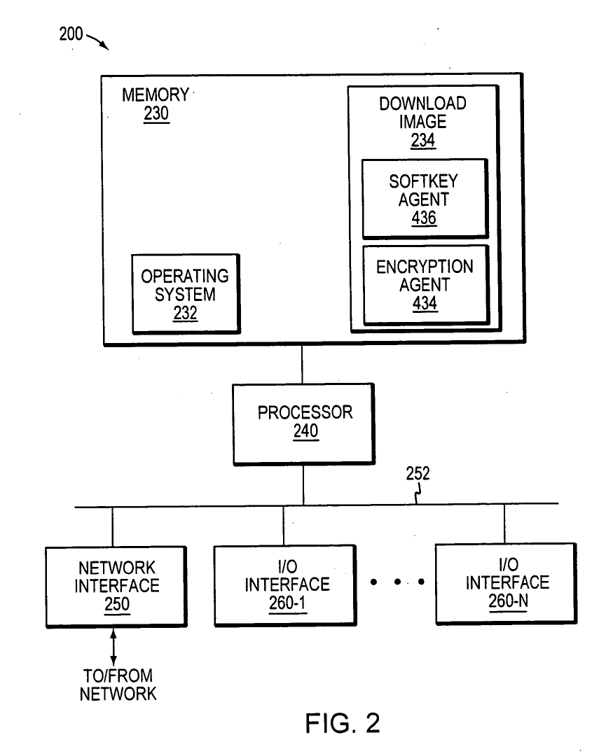

Server 200 is illustratively a conventional server configured to provide an encryption agent download image to the communication units 300. FIG. 2 is a high-level partial schematic block diagram of a server 200 that may be used with the present invention. Server 200 comprises memory 230, a processor 240, and a network interface 250 and one or more I/O interfaces 260 coupled to the processor via an input/output (I/O) bus 252.

The processor 240 is a conventional processor configured to execute computer executable instructions contained in memory 230. The network interface 250 is a conventional network interface comprising logic which illustratively interfaces the communication device 300 with the network 100 and enables communications to be transferred between the communication device 300 and the network 100. The I/O interfaces 260 comprises logic which interfaces various input and/or output devices with the processor 240, such as keyboards, display units and mice.

The memory 230 is a computer-readable medium organized as a random access memory (RAM) that is illustratively implemented using RAM devices, such as dynamic random access memory (DRAM) devices. The memory 230 is configured to hold computer executable instructions and data structures including computer executable instructions and data structures that implement aspects of the present invention. The memory 230 contains an operating system 232 and a download image 234. The operating system 232 is a conventional multi-tasking operating system configured to implement various conventional operating system functions, such as scheduling tasks and programs for execution as well as managing memory 230. The download image 234 is a software image that illustratively contains an encryption agent 434 and a soft key agent 436 (both described further below) which are packaged as a single software image that is capable of being downloaded to and installed at the communication units 300-1, 300-2.

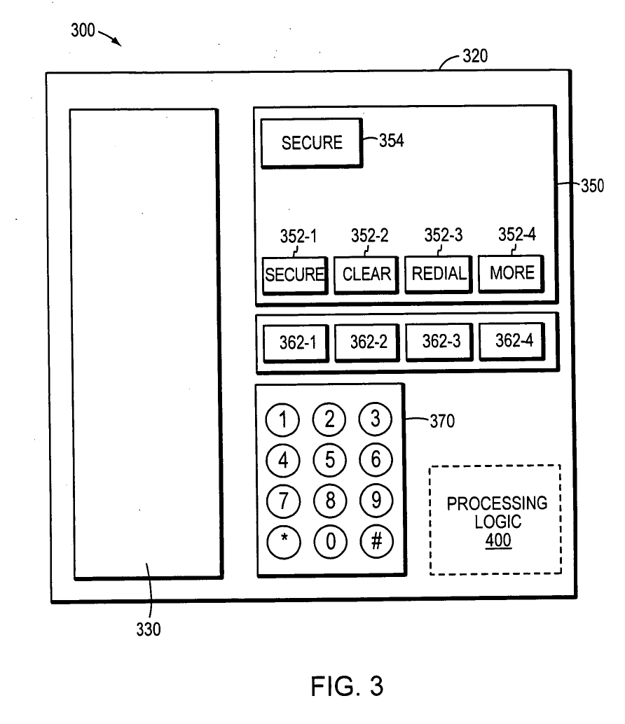

Communication units 300 are illustratively telephone units that enable telephone calls to be initiated and received in network 100. FIG. 3 is a high-level schematic block diagram of a communication unit 300 that may be used with the present invention. A communication unit that may be used with the present invention is the Cisco IP phone 7960 available from Cisco Systems, Inc., San Jose, Calif. 95134.

Communication unit 300 comprises a base unit 320, a handset 330, a display unit 350, one or more soft keys 362, a keypad 370 and processing logic 400. The base unit 320 is a conventional base unit configured to enclose the processing logic 400 as well as provide a platform for the display unit 350, the soft keys 360 and the keypad 370. The base unit 320 also provides a cradle for the handset 330. The handset 330 is a conventional telephone handset comprising circuitry configured to convert between sound waves and electronic signals usable by processing logic 400. The soft keys 362 are illustratively push-buttons that, as will be explained further below, may be programmed to provide various functions, such as enabling/disabling secure (encrypted) communications. The keypad 370 is a conventional keypad that is configured to generate, e.g., standard Dual Tone Multi Frequency (DTMF) tones. The display unit 350 is illustratively a liquid crystal display (LCD) that displays, inter alia, soft key descriptions 352 as well as the statuses 354 of calls handled by the unit 300. These statuses may include indicators that indicate that communications handled by the communication unit 300 are secure or “in the clear” (unencrypted).

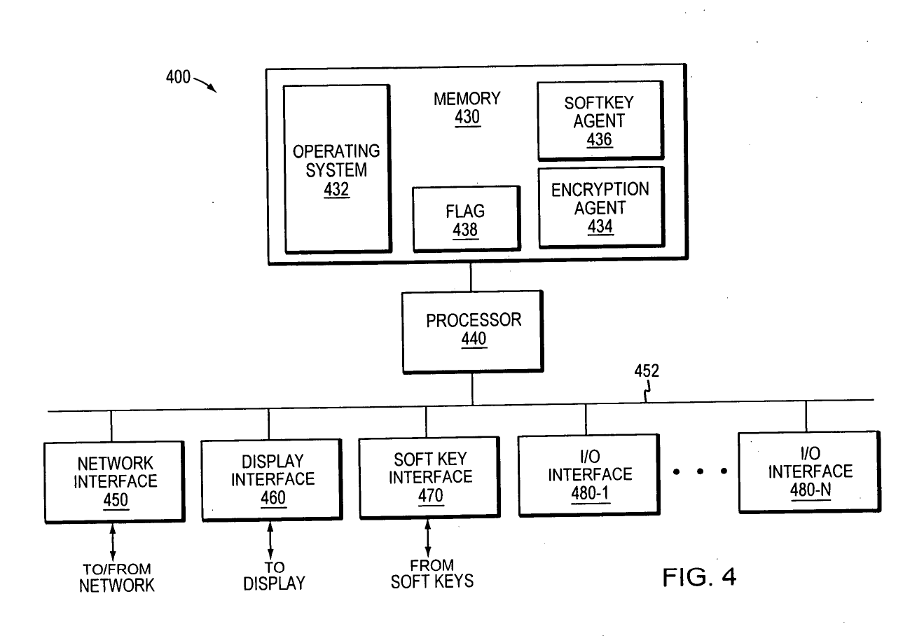

The processing logic 400 illustratively comprises logic that interfaces with the various components of the communication device 300 as well as logic that is used to implement encryption in accordance with an aspect of the present invention. FIG. 4 is a high-level partial schematic block diagram of processing logic 400 that may be used with the present invention. Processing logic 400 illustratively comprises a memory 430, a processor 440, coupled to various interfaces via an I/O bus 452. These interfaces may include a network interface 450, a display interface 460, a soft key interface 470 and one or more I/O interfaces 480. The processor 440 is a conventional processor containing logic that is configured to execute various instructions and manipulate data structures contained in memory 430. Network interface 450 is a conventional network interface comprising logic which illustratively interfaces the communication device 300 with the network 100 and enables communications to be transferred between the communication device 300 and the network 100. The display interface 460 illustratively comprises logic configured to enable processor 440 to access the display unit 350 and display information associated with the communication device 300, such as soft key descriptions 352 and status 354. The soft key interface 470 comprises logic which interfaces the soft keys 362 with the processor 440 and enables the processor 440 to determine if a soft key 362 has been selected. The I/O interfaces 480 comprises logic which interfaces various input and/or output devices with the processor 440, such as keypad 370 and handset 330.

The memory 430 is a computer-readable medium organized as a random access memory that is illustratively implemented using RAM devices. The memory 430 may be implemented using some combination of volatile and non-volatile memory devices, such as DRAM devices and flash memory devices. The memory 430 is configured to hold various computer executable instructions and data structures including computer executable instructions and data structures that implement aspects of the present invention. It should be noted that other computer-readable mediums, such as disks, may be configured to hold computer executable instructions and data that implement aspects of the present invention. In addition, various electromagnetic signals may be encoded to carry computer executable instructions and data that implement aspects of the present invention.

The memory 430 holds software including an operating system 432, a soft key agent 436 and an encryption agent 434. The operating system 432 is illustratively a conventional operating system, suitable for embedded systems, that is configured to implement various conventional operating system functions, such as task and process scheduling as well as memory management. The soft key agent 436 is illustratively a software applet that is written in the extensible Markup Language (XML). The soft key agent 436 illustratively contains various software routines that define various functions associated with the soft keys 362, such as enabling/disabling encryption.

The encryption agent 434 is a software program that enables the communication unit 300 to encrypt/decrypt communications. Illustratively, encryption agent 434 is configured to encrypt/decrypt communications using a public key encryption technique. A public key encryption technique that may be used with the present invention is the well-known Pretty Good Privacy (PGP) technique which is available from PGP Corporation, Palo Alto, Calif. 94303.

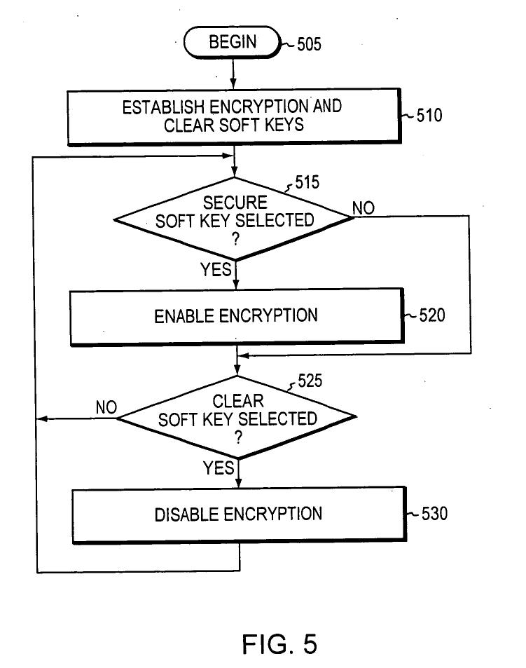

FIG. 5 is a flow chart of a sequence of steps that may be used to implement the soft key agent 436 in accordance with an aspect of the present invention. The sequence begins at step 505 and proceeds to step 510 where the secure soft key 362-1 is established to enable encrypted communications and the clear soft key 362-2 is established to disable encrypted communications.

It should be noted that in other embodiments of the invention, a single soft key is used to enable or disable encrypted communications on the communication unit 300. Here, the soft key is illustratively configured to toggle between enabling and disabling encrypted communications on the unit 300.

At step 515, a check is performed to determine if the secure soft key 362-1 has been selected (depressed). If not, the sequence proceeds to step 525. Otherwise, the sequence proceeds to step 520 where encryption is enabled for the communication unit 300. Illustratively, encryption is enabled by displaying the status indicator 354 on screen 350 and setting the flag 438 to indicate encryption is enabled.

At step 525, a check is performed to determine if the clear soft key 362-2 has been selected (depressed). If not, the sequence returns to step 515. Otherwise, the sequence proceeds to step 530 where encryption is disabled for the communication unit 300 illustratively by removing the status indicator 354 on screen 350 and setting the flag 438 to indicate encryption is not enabled. The sequence returns to step 515.

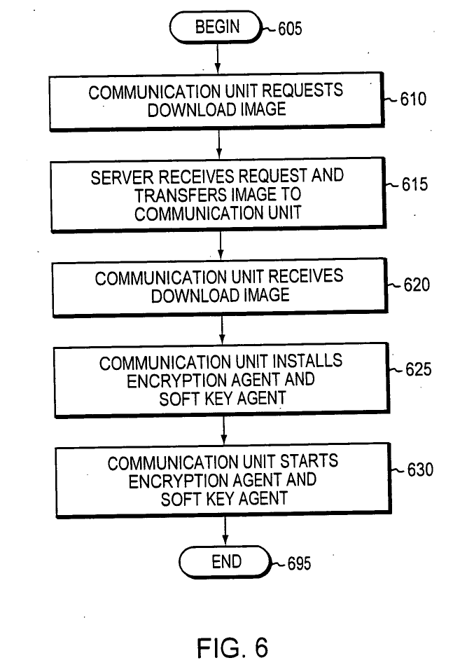

In accordance with an aspect of the present invention, the download image 234 is downloaded to the communication units 300 which install and execute the soft key agent 436 and encryption agent 434 contained therein. FIG. 6 is a flow chart of a sequence of steps that may be used to download the download image 234 to a communication unit 300 and install the encryption agent 434 and soft key agent 436 contained therein at the communication unit 300 in accordance with an aspect of the present invention.

The sequence begins at step 605 and proceeds to step 610 where the communication unit 300 requests the download image 234. Illustratively, this request is made when the communication unit 300 is powered up and connected to the network 100. At step 615, a server 200 receives the request and responds by transferring the download image 234 to the requesting communication unit 300. At step 620, the communication unit 300 receives the download image and, at step 625, installs the encryption agent 434 and soft key agent 436 contained therein. Illustratively, the download image 434 is received by the communication unit 300 via the communication unit's network interface 460 and installed in the communication unit's memory 430. At step 630, the communication unit 300 starts the soft key agent 436 and encryption agent 434 by executing them. The sequence ends at step 695.

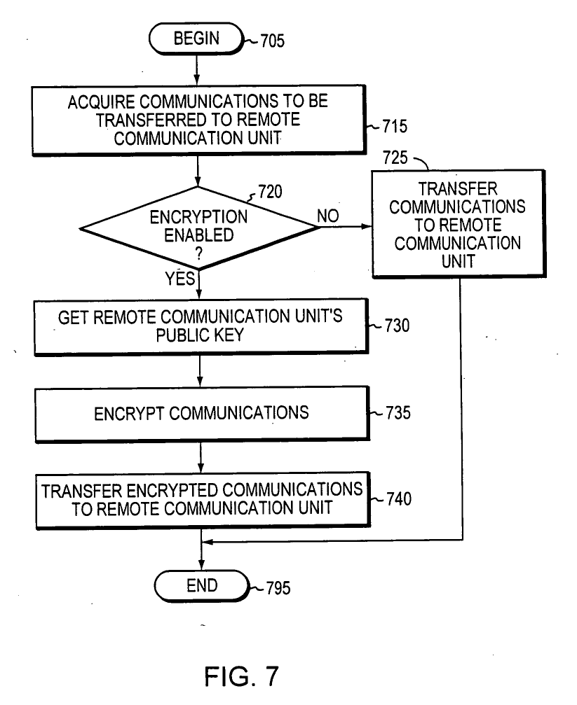

In accordance with the present invention, communications transferred from a communication unit 300 onto the network 100 may be secure or “in the clear” depending on whether encryption is enabled or disabled. FIG. 7 is a flow chart of a sequence of steps that may be used to transfer communications from a local communication unit 300 to a remote communication unit 300 in accordance with an aspect of the present invention.

The sequence begins at step 705 and proceeds to step 715 where the local communication unit acquires the communications that are transferred to the remote communication unit. Illustratively, the communications may be voice communications that have been acquired by the local communication unit's handset 330. Next, at step 720, a check is performed to determine if encryption is enabled on the local communication unit. Illustratively, the local communication unit's processor 440 checks the flag 438 to determine if it indicates whether encryption is enabled. If encryption is not enabled, the sequence proceeds to step 725 where the local communication unit transfers the acquired communications “in the clear” to the remote communication unit via network 100.

If encryption is enabled, the sequence proceeds to step 735, where the local communication unit encrypts the acquired communications, illustratively, by using a public key of the remote communication unit. Next, at step 740, the local communication unit transfers the encrypted communications to the remote communication unit illustratively via network 100. The sequence ends at step 795.

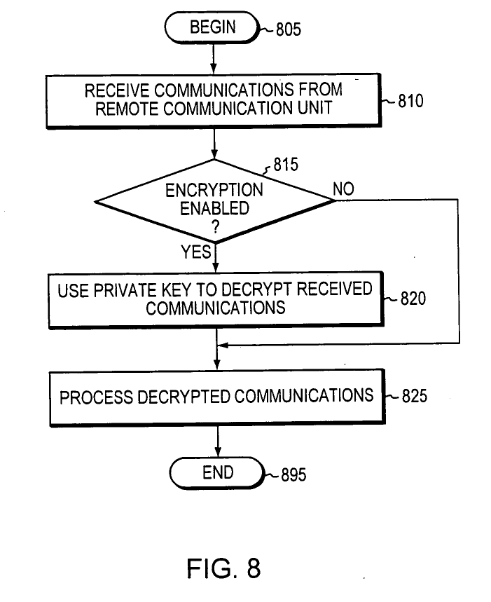

FIG. 8 is a flow chart of a sequence of steps that may be used to decrypt communications received by a local communication unit from a remote communication unit in accordance with an aspect of the present invention. The sequence begins at step 805 and proceeds to step 810 where the local communication unit receives the encrypted communications from the remote communication unit. Next, at step 815, a check is performed to determine if encryption is enabled. Illustratively, the local communication unit's processor 440 checks the flag 438 to determine if it indicates that encryption is enabled. If encryption is not enabled, the communications are considered to be “in the clear” and the sequence proceeds to step 825. Otherwise, the sequence proceeds to step 820 where the received communications are decrypted illustratively using the local communication unit's private key to produce communications that are “in the clear.” At step 825, the “in the clear” communications are further processed by the local communication unit which may illustratively include using the communications to produce audible sound waves on the local communication unit's handset 330 or displaying information on the local communication unit's display 350.

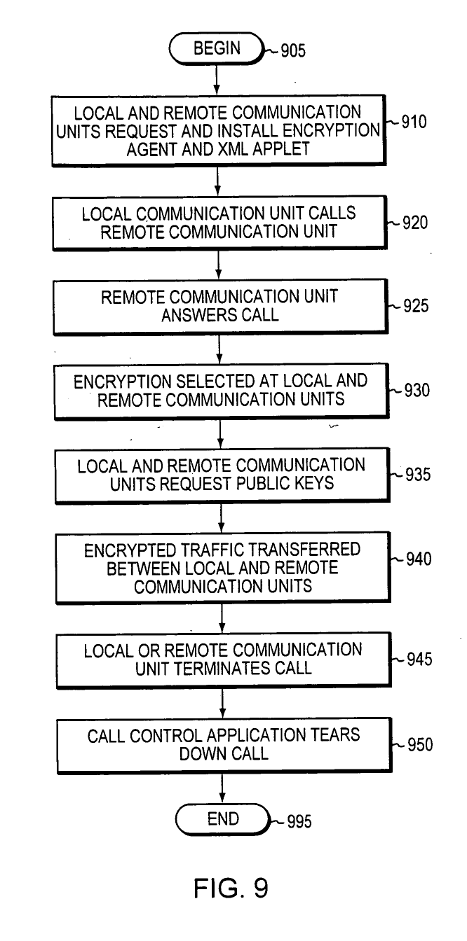

FIG. 9 is a flow chart of a sequence of steps that may be used to establish an encrypted telephone call from a local communication unit to a remote communication unit in accordance with an aspect of the present invention. The sequence begins at step 905 and proceeds to step 910 where the local and remote communication units request and install the download image 234, as described above. Next at step 920 the local communication unit places a call to the remote communication unit. Illustratively, the local communication unit sends a request to the call control application 170 (FIG. 1) to establish a call to the remote communication unit. The call control application 170 illustratively establishes the call through VoIP network 160 including allocating resources in network 100 for the call using conventional VoIP techniques.

At step 925, the call is answered at the remote communication unit. At step 930, encryption is selected (enabled) at both the local and the remote communication units, as described above. Next, at step 935, the local and remote communication units request public keys. Illustratively, the local communication unit sends a request for the remote communication unit's public key and vice-versa via network 100 to the certificate authority 180 (FIG. 1). The certificate authority 180 transfers the requested public key to the requesting remote communication unit 300, accordingly.

At step 940, encrypted communications are transferred between the local and remote communication units. At step 945, either the local or the remote communication unit hangs up, thus ending the call. At step 950, the call control application 170 tears down the call illustratively using conventional VoIP techniques. The sequence ends at step 995.

For example, assume a user at a local communication unit 300-1 wishes to make a secure call to a user at a remote communication unit 300-2. At step 910 the local and remote communication units 300-1, 300-2 request and install the encryption agent image 234 from servers 200-1, 200-2, respectively.

Specifically, for each communication unit 300, the processing module 400 on the communication unit 300 issues a request to the associated server 200 to download the down load image 234. The server 200 processes the request and transfers the download image 234 to the communication unit 300. The communication unit 300 extracts the soft key agent 436 and encryption agent 434 from the image 234 and places them in its memory 430. The processor 440 then executes the encryption agent 434 and the soft key agent 436. The soft key agent 436 illustratively displays text 352-1 and text 352-2 on display 350 to indicate that soft keys 362-1 and 362-2 are configured to enable/disable encrypted communications on the communication unit 300, respectively.

At step 920, the user at local communication unit 300-1 calls the remote communication unit 300-2. Illustratively, the call is signaled from the local communication unit 300-1 to the call control application 170. The call control application 170 establishes the call between units 300-1 and 300-2 through network 100 illustratively in accordance with conventional VoIP techniques.

At step 925, the user at the remote communication unit 300-2 answers the call. Since the users wish to make the call secure, they select the secure communications by illustratively depressing the secure soft key 362-1 at their respective communication units 300 (step 930). In response to selecting the secure communications, the communication units 300-1, 300-2 request public keys from the certificate authority 180 via network 100, as described above.

After the communication units 300 have received the requested public keys, communications are encrypted and transferred between the communication units 300. Illustratively, communications are acquired by a communication unit 300 via its handset 330 which are encrypted by the communication unit 300 using the encryption agent 434. The communication unit 300 sends the encrypted communications over the network 100 to the other communication unit 300. The encrypted communications are eventually received by the other communication unit 300 which decrypts them to produce “in the clear communications” and produces audible sound waves based on the decrypted communications that may be heard at the handset 330.

Eventually, the call is terminated at either the local or remote unit (step 945). At this point, a disconnect signal is sent from the communication unit 300 that is terminating the call to the call control application 170 which responds by tearing down the call (step 950).

While this invention has been particularly shown and described with references to preferred embodiments thereof, it will be understood by those skilled in the art that various changes in form and details may be made therein without departing from the scope of the invention encompassed by the appended claims.

What is claimed is:

1. A computer-readable medium comprising computer executable instructions for:
installing an encryption agent on a communication unit in a communications network; and
using the encryption agent to encrypt communications handled by the communication unit for transfer on the communications network.

2. A computer-readable medium as defined in claim 1 wherein the communication unit is a telephone.

3. A computer-readable medium as defined in claim 1 further comprising computer executable instructions for:
acquiring a public key of a remote communications unit in the communications network that is to receive the encrypted communications; and
using the public key to encrypt the communications.

4. A computer-readable medium as defined in claim 1 further comprising computer executable instructions for:
installing a soft key agent on the communication unit wherein the soft key agent is configured to enable encryption on the communication unit using a soft key.

5. A computer-readable medium as defined in claim 4 wherein the soft key agent is an eXtensible Markup Language (XML) applet.

6. A computer-readable medium as defined in claim 1 further comprising computer executable instructions for:
receiving a download image that contains the encryption agent.

7. A computer-readable medium as defined in claim 6 further comprising computer executable instructions for:
requesting the download image.

8. A computer-readable medium as defined in claim 6 wherein the download image further comprises a soft key agent configured to enable encryption on the communication unit using a soft key.

9. A computer-readable medium as defined in claim 1 further comprising computer executable instructions for:
establishing a soft key that is used to enable encryption on the communication unit; and
enabling encryption if the soft key is selected.

10. A computer-readable medium as defined in claim 9 further comprising computer executable instructions for:
encrypting communications if encryption is enabled.

11. A computer-readable medium as defined in claim 9 further comprising computer executable instructions for:
receiving encrypted communications; and
decrypting the received communications if encryption is enabled.

12. A computer-readable medium as defined in claim 1 further comprising computer executable instructions for:
establishing a soft key that is used to disable encryption on the communication unit; and
disabling encryption if the soft key is selected.

13. A computer-readable medium comprising computer executable instructions for:
receiving a request for a download image containing an encryption agent for encrypting communications transferred in a communications network; and
transferring the download image to a communications unit in the communications network.

14. A computer-readable medium as defined in claim 13 wherein the download image contains a soft key agent for enabling and disabling encryption on the communication unit.

15. A method for encrypting communications for transfer on a communications network, the method comprising:
installing an encryption agent on a communication unit in the communications network; and
using the encryption agent to encrypt communications handled by the communication unit for transfer on the communications network.

16. A method as defined in claim 15 further comprising:
acquiring a public key of a remote communications unit in the communications network that is to receive the encrypted communications; and
using the public key to encrypt the communications.

17. A method as defined in claim 15 further comprising:
installing a soft key agent on the communication unit wherein the soft key agent is configured to enable encryption on the communication unit using a soft key.

18. A method as defined in claim 15 further comprising:
receiving a download image that contains the encryption agent.

19. A method as defined in claim 18 further comprising:
requesting the download image.

20. A method as defined in claim 15 further comprising:
establishing a soft key that is used to enable encryption on the communication unit; and
enabling encryption if the soft key is selected.

21. A method as defined in claim 20 further comprising:
encrypting communications if encryption is enabled.

22. A method as defined in claim 20 further comprising:
receiving encrypted communications; and
decrypting the received communications if encryption is enabled.

23. A method as defined in claim 15 further comprising:
establishing a soft key that is used to disable encryption on the communication unit; and
disabling encryption if the soft key is selected.

24. A communications device for encrypting communications for transfer on a communications network, the communications device comprising:
a memory containing an encryption agent; and
a processor coupled to the memory, the processor configured to:
use the encryption agent to encrypt communications for transfer on a communications network.

25. A communications device as defined in claim 24 wherein the processor is further configured to:
establish a soft key that is used to enable encryption.

26. A communications device as defined in claim 25 wherein the processor is further configured to:
encrypt communications if encryption is enabled.

27. A communications device as defined in claim 25 wherein the processor is further configured to:
receive encrypted communications; and
decrypt the received communications if encryption is enabled.

28. A communications device as defined in claim 25 wherein the processor is further configured to:
establish a soft key that is used to disable encryption.

29. An apparatus for encrypting communications for transfer on a communications network, the apparatus comprising:
means for installing an encryption agent on a communication unit in the communications network; and
means for using the encryption agent to encrypt communications handled by the communication unit for transfer on the communications network.

30. Electromagnetic signals traveling on a data network, the electromagnetic signals carrying instructions for execution on a processor for:
installing an encryption agent on a communication unit in a communications network; and
using the encryption agent to encrypt communications handled by the communication unit for transfer on the communications network.
